(19) United States
(12) Patent Application Publication
(10) Pub. No.: US 2004/0185945 A1
(43) Pub. Date: Sep. 23, 2004

(54) Tapered slot coupling

(76) Inventors: Richard J. Barron, Ann Arbor, MI (US); Harry A. Hunnicutt, Ann Arbor, MI (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/393,740

(22) Filed: Mar. 21, 2003

(51) Int. Cl. F16D 3/18; F16D 3/44

(52) U.S. Cl. 464/157

(57) ABSTRACT

A coupling having slots for receiving drive tabs of an associated driving shaft and a driven shaft, wherein the tabs of the driving shaft and the driven shaft are tapered to militate against rotational play between the driving shaft and the driven shaft which results in undesirable wear and damage to the drive shafts and coupling.

### FIELD OF THE INVENTION

The invention relates to a coupling and more particularly to a coupling having slots for receiving drive tabs of an associated driving shaft and a driven shaft, wherein the tabs of the driving shaft and the driven shaft are tapered to militate against rotational play between the driving shaft and the driven shaft.

### BACKGROUND OF THE INVENTION

Couplings are known in the art for interconnecting a rotatable driving shaft and a rotatable driven shaft. The driving shaft is typically driven by a prime mover or motor, and the driven shaft is connected to and drives a rotatable machine or load such as a pump or compressor, for example. Rotation of the driving shaft causes a corresponding rotation of the driven shaft via the coupling. The coupling allows for slight misalignment of the driving and driven shafts such as radial offsets, angular misalignments of the axes of the shafts, or both.

One such coupling is the “insert (3-jaw) type”, such as that manufactured by Boston Gear, in which each coupling half (coupling body) has three axially extending jaws spaced about the circumference of a respective plate-like end flange. A spider with six radially outwardly extending legs is disposed between the coupling halves, and the couplings are axially positioned so that the each jaw of one coupling half is disposed between two jaws of the other coupling half, and separated from each of the two jaws of the other coupling half by a respective one of the spider legs. The spider is typically made of a material which is relatively softer than that of which the coupling halves are made. It is known to make the spiders of oil-impregnated bronze, synthetic rubber, polyurethane, urethane, and co-polymer thermoplastic elastomers. When one of the coupling halves is rotated, torque is transmitted from each of the jaws of the driven coupling half, through an adjacent one of the spider legs to the adjacent jaw of the other coupling half, thereby causing rotation of the other coupling half. Because the jaws and spider surfaces are flat, axially oriented surfaces, this arrangement allows for a certain amount of rotational play and backlash.

Other couplings currently known in the art often permit this undesirable rotational play or backlash between the driving shaft and the driven shaft. The rotational play can result in undesirable wear and damage to the shafts and the couplings. Additionally, undesirable noise and vibration to the load or prime mover can result.

Manufacturers have attempted to control rotational play using couplings of two types. One type includes elastomeric coupling elements which deform to form a close fit to the driving shaft and the driven shaft (similar to the “insert (3-jaw) type”). The inclusion of the elastomeric coupling elements may prevent the coupling from being used under certain environmental conditions. Another type requires some form of fastening to the driving and driven members to eliminate relative motion, thereby causing an undesirable increase in production costs.

It would be desirable to produce a coupling which militates against rotational play between the driving shaft and the driven shaft.

### SUMMARY OF THE INVENTION

Consistent and consonant with the present invention, a coupling which militates against rotational play between the driving shaft and the driven shaft has been developed.

The coupling comprises:

a driving shaft having a first end and a second end, the first end adapted to be driven by a prime mover and the second end having a pair of tabs extending axially outwardly therefrom;

a driven shaft having a first end and a second end, the first end adapted for connection to a rotating machine and the second end having a pair of tabs extending axially outwardly therefrom;

a coupling main body having a central aperture formed therein, the aperture adapted to receive the tabs of the driving shaft and the tabs of the driven shaft in opposing sides thereof to transfer rotation from the driving shaft to the driven shaft, wherein at least one side of the tabs of the driving shaft is tapered and at least one side of the tabs of the driven shaft is tapered; and

a bearing system adapted to urge the driving shaft and the driven shaft towards one another and resist reaction forces generated during rotation of the driving shaft and the driven shaft to maintain engagement between the driving shaft, the driven shaft, and the coupling main body.

### DESCRIPTION OF THE DRAWINGS

Various objects and advantages of this invention will become apparent to those skilled in the art from the following detailed description of the preferred embodiment, when read in light of the accompanying drawings, in which:

FIG. 1 is an exploded perspective view of a first embodiment of the coupling in accordance with the present invention including a driving shaft and a driven shaft, wherein both the driving shaft and the driven shaft include axially extending tabs having tapered sides;

FIG. 2 is a partial cross-sectional view of the coupling of FIG. 1 taken along line 2-2 and shown assembled;

FIG. 3 is a partial cross-sectional view of the coupling of FIG. 1 taken along line 3-3 and shown assembled;

FIG. 4 is a schematic view of a bearing assembly in accordance with the present invention; and

FIG. 5 is a perspective view of a second embodiment of a bearing assembly in accordance with the present invention showing a driving shaft end, a coupling, and a driven shaft end exploded, and the bearing assembly shown schematically.

### DESCRIPTION OF THE PREFERRED EMBODIMENT

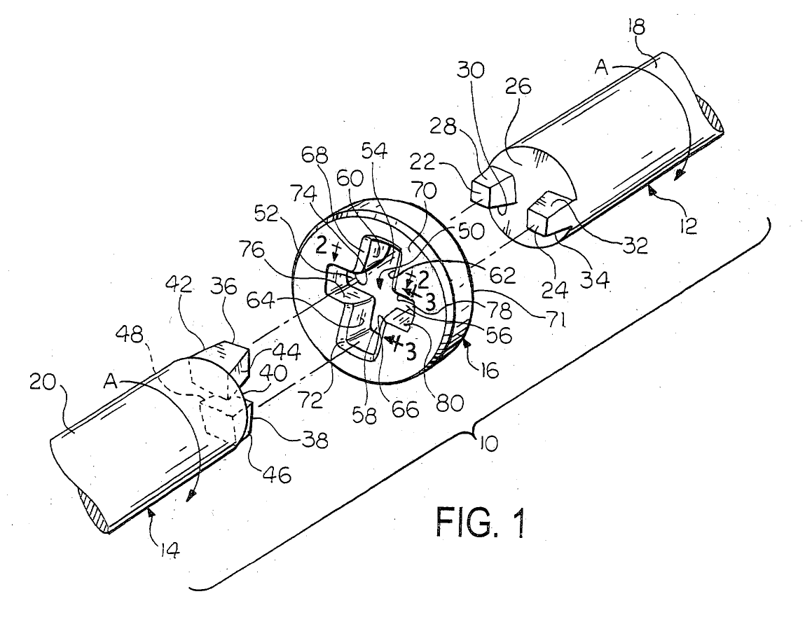

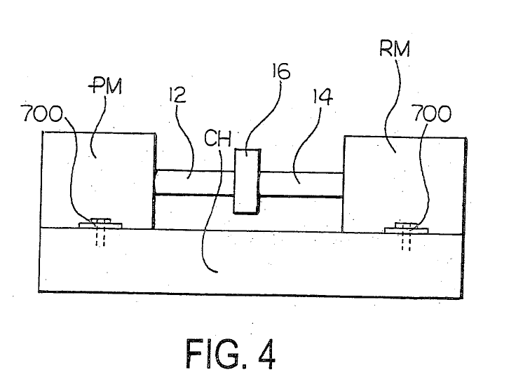

Referring now to the drawings, and particularly FIG. 1, there is shown generally at 10 a shaft coupling assembly incorporating the features of the invention. The shaft coupling assembly 10 includes a driving shaft 12, a driven shaft 14, and a coupling main body 16. A direction of rotation ‘A’ is shown for both the driving shaft 12 and the driven shaft 14. A first end 18 of the driving shaft 12 is drivingly engaged with a prime mover PM, shown schematically in FIG. 4, such as a motor, for example. A first end 20 of the driven shaft 14 is drivingly engaged with a rotatable machine RM, shown schematically in FIG. 4, such as a pump or compressor, for example.

A pair of diametrically opposed tabs 22, 24 extend axially outwardly from a second end 26 of the driving shaft 12. At least one side 28, 30 of the tab 22 and at least one side 32, 34 of the tab 24 are tapered to narrow the width of each of the tabs 22, 24 when moving axially away from the second end 26 towards the driven shaft 14. In the embodiment shown, both of the sides 28, 30 and both of the sides 32, 34 are tapered. Where only one side of each of the tabs 22, 24 of the driving shaft 12 is tapered, the sides 30, 32 facing away from the direction of rotation ‘A’ are preferably tapered. Desirable results are achieved with a taper in the range of 1 degree to 20 degrees from a longitudinal axis of the driving shaft 12, with even more desirable results obtained using a taper of 5 degrees. In an exemplary application of the invention embodied as a motor and pump unit for an electrohydraulic brake system for a passenger automobile, it was calculated that forming shafts with a taper in such a range, and most optimally a taper of 5 degrees, required the least preload that was achievable with manageable tolerancing for acceptably priced manufacturing processes.

A pair of diametrically opposed tabs 36, 38 extend axially outwardly from a second end 40 of the driven shaft 14. At least one side 42, 44 of the tab 36 and at least one side 46, 48 of the tab 38 are tapered to narrow the width of each of the tabs 36, 38 when moving axially away from the second end 40 towards the driving shaft 12. In the embodiment shown, both of the sides 42, 44 and both of the sides 46, 48 are tapered. Where only one side of each of the tabs 36, 38 of the driven shaft 14 is tapered, the sides 44, 48 facing away from the direction of rotation ‘A’ are preferably tapered. Desirable results are achieved with a taper in the range of 1 degree to 20 degrees from a longitudinal axis of the driven shaft 14, with even more desirable results obtained using a taper of 5 degrees. As indicated above, such a taper is small enough such that torque will not overcome the axial preload and drive the shafts apart, and large enough to allow easily achievable manufacturing tolerances on mating parts. The tabs 22, 24 of the driving shaft 12 are offset ninety degrees from the tabs 36, 38 of the driven shaft 14 in the embodiment shown. It is understood that tabs having different offset angles could be used without departing from the scope and spirit of the invention.

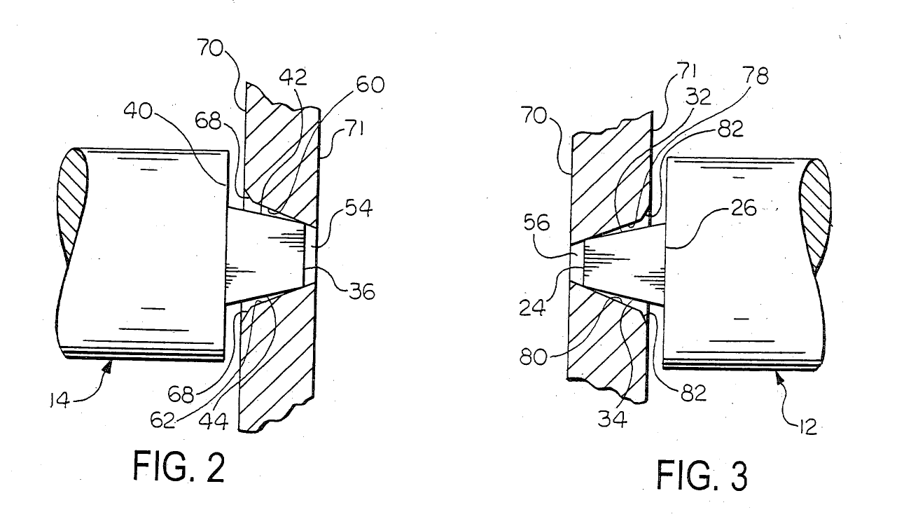

The coupling main body 16 includes a central aperture 50 having four outwardly extending lobes 52, 54, 56, 58 forming a cross-shaped aperture. The lobes 54, 58 are adapted to receive the tabs 36, 38, respectively. In the embodiment shown, side walls 60, 62 forming the lobe 54 and side walls 64, 66 forming the lobe 58 are sloped such that contact with the tabs 36, 38 is linear, as clearly shown in FIG. 3. Additionally, the linear contact is preferably made along a line closer to a second surface 71 than a first surface 70. It is understood that other contact configurations could be used without departing from the scope and spirit of the invention. For example, the entire surface of the side walls 60, 62 may contact the entire surface of the sides 42, 44 of the tab 36, respectively, and the entire surface of the sides 64, 66 may contact the entire surface of the sides 46, 48 of the tab 38, respectively. As clearly illustrated in FIGS. 1 and 2, a bevel 68 surrounds the lobe 54 adjacent the first surface 70 of the coupling main body 16. Additionally, a bevel 72 surrounds the lobe 58 adjacent the first surface 70.

The lobes 52, 56 are adapted to receive the tabs 22, 24, respectively. In the embodiment shown, side walls 74, 76 forming the lobe 52 and side walls 78, 80 forming the lobe 56 are sloped such that contact with the tabs 22, 24 is linear, as clearly shown in FIG. 2. Additionally, the linear contact is preferably made along a line closer to the first surface 70 than the second surface 71. It is understood that other contact configurations could be used without departing from the scope and spirit of the invention. For example, the entire surface of the side walls 74, 76 may contact the entire surface of the sides 28, 30 of the tab 22, respectively, and the entire surface of the sides 78, 80 may contact the entire surface of the sides 32, 34 of the tab 24, respectively.

A bevel (not shown) surrounds the lobe 52 adjacent the second surface 71 of the coupling main body 16. A bevel 82 surrounds the lobe 56 adjacent the second surface 71 of the coupling main body 16, as shown in FIG. 3.

In the embodiment shown, a distance from an outer edge of the tab 22 to an outer edge of the tab 24 of the driving shaft 12 differs from a distance from an outer edge of the tab 36 to an outer edge of the tab 38 of the driven shaft 14. The difference militates against improper insertion of the tabs 22, 24, 36, 38 into the coupling main body 16. The tabs 36, 38 also have a different cross sectional area than the tabs 22, 24 so they cannot be inserted in the lobes 52, 56.

To assemble, the tabs 22, 24 of the driving shaft 12 are inserted into the lobes 52, 56, respectfully. The bevel (not shown) and the bevel 82 guide the tabs 22, 24 into the lobes 52, 56, respectively. The tabs 36, 38 of the driven shaft 14 are inserted into the lobes 54, 58, respectfully. The bevels 68, 72 guide the tabs 36, 38 into the lobes 54, 58, respectively. The tapers ensure that the tabs 22, 24, 36, 38 can only be inserted in the larger opening side of the respective mating lobe 52, 56, 54, 58 in the coupling main body 16.

Referring now to FIG. 4, a system utilizing the shafts 12, 14 and coupling main body 16 is schematically shown. The prime mover PM is provided which drives the driving shaft 12. A bearing system 700 is provided for the prime mover PM to transmit axial forces to and from a chassis CH. In the schematic illustration, the bearing system 700 could be, for example, a flange formed on the prime mover PM and a bolt fastening the flange to the chassis CH. However, as will be readily recognized by one of ordinary skill in the art, there are various suitable bearing systems well known in the art for transmitting forces between objects. Such bearing systems may involve fasteners such as bolts which militate against relative movement between components, and systems which permit some relative movement between components while still transmitting forces. Any suitable one of these bearing systems could be used.

Also illustrated in FIG. 4 is a rotatable machine RM, which is caused to rotate by the driven shaft 14. The rotatable machine RM is provided with a respective suitable bearing system 700 to transmit forces between the rotatable machine RM and the chassis CH. It should be understood that the bearing system 700 associated with the rotatable machine RM may be different in design and function from the bearing system 700 associated with the prime mover PM.

For the sake of ease of schematic illustration, the prime mover PM and the rotatable machine RM are illustrated as being operatively connected by respective bearing systems to a separate chassis CH. However, it should be clearly understood that in many instances the prime mover PM and the rotatable machine RM may be directly operatively connected by a shared bearing system (not shown). For example, the prime mover PM and the rotatable machine RM may be bolted to one another.

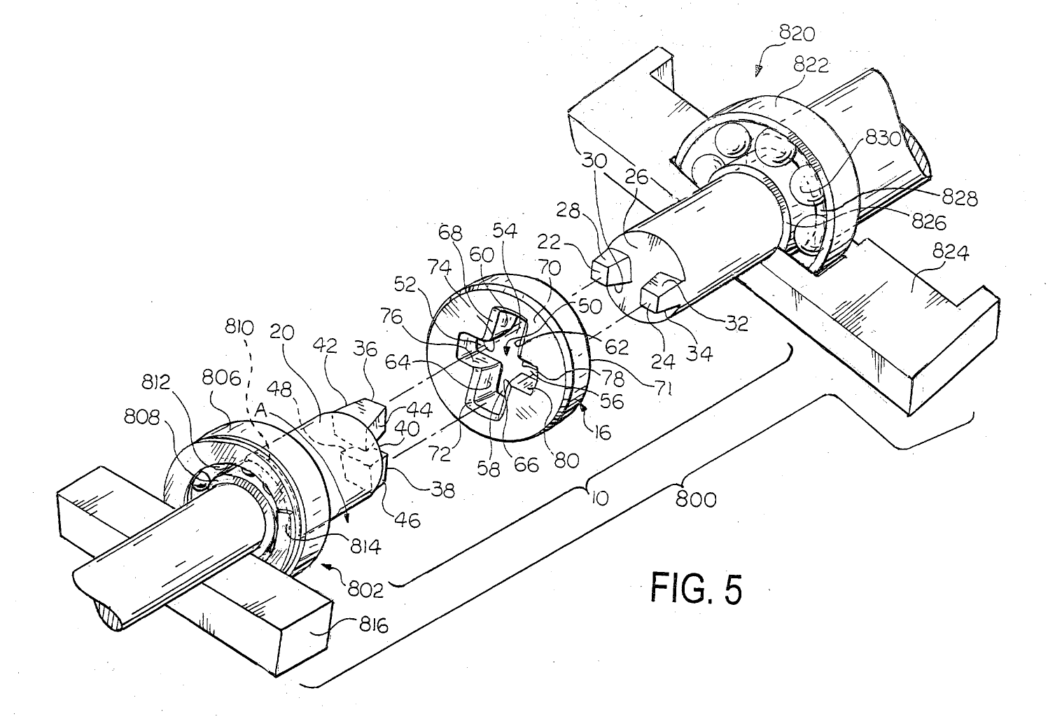

Referring now to FIG. 5, there is shown a second embodiment of a shaft and bearing system 800. The shaft and bearing system 800 includes a shaft coupling assembly 10 as illustrated in FIG. 1 and previously described herein. A preloaded bearing 802 is disposed on the driven shaft 14 which permits movement of the bearing 802 in a direction along the axis of the driven shaft 14. The bearing 802 includes an outer race 806 and an inner race 808. The inner race 808 of the bearing 802 abuts a step 810 formed in an outer surface of the driven shaft 14. A plurality of balls 812 is disposed between the inner race 808 and the outer race 806 of the bearing 802 to permit rotational movement therebetween. A spring 814 abuts the outer race 806 of the bearing 802 to urge the bearing 802 and the driven shaft 14 towards engagement with the coupling main body 16 and the driving shaft 12. The spring 814 also abuts and is held in place by a wall or restricting frame 816. The inner race 808 abuts the step 810 on the driven shaft 14 to cause the driven shaft 14 to be urged towards the coupling main body 16 and the driving shaft 12 due to urging of the preload bearing 802 by the spring 814.

The driving shaft 12 has a bearing 820 disposed thereon. An outer race 822 of the bearing 820 is restrained from axial movement in respect of the driving shaft 12 by a wall or restricting frame 824. An inner race 826 of the bearing 820 abuts a step 828 formed in an outer surface of the driving shaft 12. A plurality of balls 830 is disposed between the inner race 826 and the outer race 822 of the bearing 820 to permit rotational movement therebetween. Thus, the driving shaft 12 and the bearing 820 are restricted from movement axially by the cooperation of the wall 824 and the step 828. As the components of the shaft coupling assembly 110 wear during use, the spring 814 urges the driven shaft 14, the coupling main body 16, and the driving shaft 12 into snug engagement, thereby compensating for the wear.

Additionally, it should be understood that other bearing systems could be used without departing from the scope and spirit of the invention. Although a ball-type bearing has been described, it is understood that any conventional bearing system where one bearing is preloaded by a spring and one bearing is capable of receiving an axial thrust load can be used. In the types of bearing systems described herein, some relative movement between the components is permitted to compensate for wear on the components of the shaft coupling assembly 10.

In operation, the driving shaft 12 is caused to rotate by the prime mover PM, which causes the coupling main body 16, the driven shaft 14, and the rotatable machine RM to rotate. The tapered sides 28, 30, 32, 34 of the driving shaft 12 and the tapered sides 42, 44, 46, 48 of the driven shaft 14 militate against rotational play between the driving shaft 12, the driven shaft 14, and the coupling main body 16.

Interaction of the tapered sides 28, 30, 32, 34 of the driving shaft 12 and the tapered sides 42, 44, 46, 48 of the driven shaft 14 with the associated facing surfaces of the coupling main body 16 does develop reaction forces tending to drive the driving shaft 12 away from the driven shaft 14. If not resisted, these reaction forces could cause the driving shaft 12 to uncouple from the driven shaft 14. These reaction forces are, in the first instance, resisted by friction developed between the tapered side 28 or the tapered side 30, and the tapered side 32 or the tapered side 34 of the driving shaft 12, the tapered side 42 or the tapered side 44, and the tapered side 46 or the tapered side 48 of the driven shaft 14, and the respective side wall 74 or the side wall 76, the side wall 78 or the side wall 80, the side wall 60 or the side wall 62, and the side wall 66 or the side wall 64, of the coupling main body 16 (the exact surfaces developing friction depending on whether the direction of rotation is in the direction ‘A’ or counter to the direction ‘A’). Additionally, the reaction forces developed during operation tending to drive the driven shaft 14 (and the interconnected rotatable machine RM) away from the driving shaft 12 (and the interconnected prime mover PM) are resisted by the bearing systems 700 transmitting these forces to the chassis CH, which militate against the prime mover PM from being caused to move away from the rotatable machine RM.

If no chassis CH is provided, and the prime mover PM is directly coupled to the rotatable machine RM by a bearing system 700, the bearing system 700 would militate against the prime mover PM being caused to move away from the rotatable machine RM. Thus, militating against the driving shaft 12 being caused to move axially away from the driven shaft 14.

Furthermore, as will be discussed below with respect to other embodiments, a spring or other device may also be provided to provide a preload force which urges the driving shaft 12 and the driven shaft 14 into engagement. Such a preload may be introduced as part of the shaft and bearing system 800.

When compared to conventional non-tapered coupling assemblies, the shaft coupling assembly 10 of the present invention facilitates a relaxation of manufacturing tolerances for the tabs 22, 24, 36, 38 and the lobes 52, 54, 56, 58 of the coupling main body 16. The tapers also militate against backlashes during slowdown or stopping of the motor, and oscillating torque load from the prime mover PM.

As previously discussed, the side walls 74, 76 forming the lobe 52 and side walls 78, 80 forming the lobe 56 are sloped such that contact with the tabs 22, 24 is linear and the side walls 60, 62 forming the lobe 54 and side walls 64, 66 forming the lobe 58 are sloped such that contact with the tabs 36, 38 is linear. Additionally, the linear contact on the side walls 74, 76, 78, 80 is preferably made along a line closer to the first surface 70 than the second surface 71 and the linear contact on the side walls 60, 62, 64, 66 is preferably made along a line closer to the second surface 71 than the first surface 70. Rotational stability is facilitated by having the contact points disposed in this manner.

Although any conventional production process can be used, it is preferred to produce the coupling main body 16 using metal injection molding. Conventional powdered metal manufacturing methods are not well suited for forming the opposing tapers. Metal injection molding also achieves higher density when compared to powdered metal. The driving shaft 12 and the driven shaft 14 can be produced by any conventional production process such as machining (milling, grinding, broaching, etc.), forging, or cold heading for example.

The shaft coupling assembly 10 of the current embodiment presents several advantages. The shaft coupling assembly 10 is easy to assemble. Having the tabs 22, 24, 36, 38 and the lobes 52, 54, 56, 58 such that they can only be assembled one way militates against misassembly. Additionally, the shaft coupling assembly 10 is a free slide-in assembly that does not require a fastening operation of coupling elements to the driving shaft 12 and the driven shaft 14. The prime mover PM can be freely moved into and out of the operating position without performing an additional operation on the coupling elements. Other “zero backlash” couplings having only metal components require a fastening to the driving shaft 12 and the driven shaft 14.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A shaft coupling assembly comprising:
a driving shaft having a longitudinal axis, a first end, and a second end, the first end adapted to be driven by a prime mover and the second end having a pair of tabs extending axially outwardly therefrom;
a driven shaft having a longitudinal axis, a first end, and a second end, the first end adapted for connection to a rotating machine and the second end having a pair of tabs extending axially outwardly therefrom; and
a coupling main body having a central aperture formed therein, the aperture adapted to receive the tabs of said driving shaft and the tabs of said driven shaft in opposing sides thereof to transfer rotation from said driving shaft to said driven shaft;
wherein at least one side of the tabs of said driving shaft is tapered and at least one side of the tabs of said driven shaft is tapered.

2. The coupling assembly according to claim 1, including a bearing system adapted to resist reaction forces generated during rotation of said driving shaft and said driven shaft to maintain engagement between said driving shaft, said driven shaft, and said coupling main body.

3. The coupling assembly according to claim 2, wherein the bearing system includes a first bearing disposed on said driving shaft, a second bearing disposed on said driven shaft, and a spring urging at least one of the first bearing and the second bearing, wherein the first bearing, the second bearing, and the spring cooperate to urge said driving shaft and said driven shaft into engagement with said main body to compensate for wear of said driving shaft, said driven shaft, and said main body.

4. The coupling assembly according to claim 1, wherein the side of the tab of said driving shaft and the side of the tab of said driven shaft facing away from a direction of rotation of said driving shaft and said driven shaft are tapered.

5. The coupling assembly according to claim 1, wherein the aperture includes four lobes formed by an inner wall of said main body, each of the lobes of the aperture adapted to receive at least one of the tabs of said driving shaft and said driven shaft therein.

6. The coupling assembly according to claim 5, wherein at least one wall forming the lobes of the aperture is sloped to receive the at least one sloped side of the tabs of said driving shaft and the at least one side of the tabs of said driven shaft.

7. The coupling assembly according to claim 5, wherein the lobes of the aperture which receive the tabs of said driven shaft are shaped to militate against insertion of the tabs of said driving shaft therein.

8. The coupling assembly according to claim 5, wherein the lobes of the aperture which receive the tabs of said driving shaft are shaped to militate against insertion of the tabs of said driven shaft therein.

9. The coupling assembly according to claim 5, wherein a surface of each tab of said driving shaft in a driven direction is tapered and a surface of each tab of said driving shaft in a non-driven direction is tapered.

10. The coupling assembly according to claim 9, wherein a surface of each tab of said driven shaft in the driven direction is tapered and a surface of each tab of said driven shaft in the non-driven direction is tapered.

11. The coupling assembly according to claim 10, wherein the tabs of said driving shaft make linear contact with the inner wall of said main body and the tabs of said driven shaft make linear contact with the inner wall of said main body.

12. The coupling assembly according to claim 11, wherein said main body has a first side adjacent said driven shaft and a second side adjacent said driving shaft, the tabs of said driving shaft contacting the inner wall of said main body closer to the first side than the second side, and the tabs of said driven shaft contacting the inner wall of said main body closer to the second side than the first side, thereby facilitating rotational stability.

13. The coupling assembly according to claim 10, wherein the wall forming the lobes of the aperture has a taper to match the taper of the tabs of said driving shaft and the tabs of said driven shaft.

14. The coupling assembly according to claim 13, wherein the tabs of said driving shaft make surface-to-surface contact with the inner wall of said main body and the tabs of said driven shaft make surface-to-surface contact with the inner wall of said main body.

15. The coupling assembly according to claim 1, wherein the taper of the at least one side of the tabs of said driving shaft is at an angle of between one degree and twenty degrees with respect to the longitudinal axis of said driving shaft, and the taper of the at least one side of the tabs of said driven shaft is at an angle of between one degree and twenty degrees with respect to the longitudinal axis of said driven shaft.

16. The coupling assembly according to claim 1, wherein the taper of the at least one side of the tabs of said driving shaft is at an angle of five degrees with respect to the longitudinal axis of said driving shaft and the taper of the at least one side of the tabs of said driven shaft is at an angle of five degrees with respect to the longitudinal axis of said driven shaft.

17. A shaft coupling assembly comprising:
a driving shaft having a longitudinal axis, a first end, and a second end, the first end adapted to be driven by a prime mover and the second end having a pair of tabs extending axially outwardly therefrom, wherein a surface of each tab of said driving shaft in a driven direction is tapered and a surface of each tab of said driving shaft in a non-driven direction is tapered;
a driven shaft having a longitudinal axis, a first end, and a second end, the first end adapted for connection to a rotating machine and the second end having a pair of tabs extending axially outwardly therefrom, wherein a surface of each tab of said driven shaft in the driven direction is tapered and a surface of each tab of said driven shaft in the non-driven direction is tapered; and
a coupling main body having a first side, a second side, and a central aperture formed therein, the aperture having four lobes formed by an inner wall of said main body, two of the lobes of the aperture adapted to receive the tabs of said driven shaft on the first side of the main body, and two of the lobes of the aperture adapted to receive the tabs of the driving shaft on the second side of the main body, said main body facilitating the transfer of rotation from said driving shaft to said driven shaft.

18. The coupling assembly according to claim 17, wherein the tabs of said driving shaft make linear contact with the inner wall of said main body and the tabs of said driven shaft make linear contact with the inner wall of said main body.

19. The coupling assembly according to claim 18, wherein the tabs of said driving shaft contact the inner wall of said main body closer to the first side than the second side, and the tabs of said driven shaft contact the inner wall of said main body closer to the second side than the first side, thereby facilitating rotational stability

20. The coupling assembly according to claim 17, wherein the wall forming the lobes of the aperture has a taper to match the taper of the tabs of said driving shaft and the tabs of said driven shaft.

21. The coupling assembly according to claim 20, wherein the tabs of said driving shaft make surface-to-surface contact with the inner wall of said main body and the tabs of said driven shaft make surface-to-surface contact with the inner wall of said main body.

22. The coupling assembly according to claim 17, wherein the lobes, of the aperture which receive the tabs of said driven shaft are shaped to militate against insertion of the tabs of said driving shaft therein.

23. The coupling assembly according to claim 17, wherein the taper of the tabs of said driving shaft is at an angle of between one degree and twenty degrees with respect to the longitudinal axis of said driving shaft, and the taper of the tabs of said driven shaft is at an angle of between one degree and twenty degrees with respect to the longitudinal axis of said driven shaft.

24. The coupling assembly according to claim 17, wherein the taper of the tabs of said driving shaft is at an angle of five degrees with respect to the longitudinal axis of said driving shaft and the taper of the at least one side of the tabs of said driven shaft is at an angle of five degrees with respect to the longitudinal axis of said driven shaft.
